(19) United States
(12) Patent Application Publication
(10) Pub. No.: US 2018/0171966 A1
(43) Pub. Date: Jun. 21, 2018

(54) WIND TURBINE WITH ROTATING AUGMENTOR

(71) Applicant: New World Energy Enterprises Limited, County Longford (IE)

(72) Inventors: James SMYTH, County Cavan (IE); Peter SMYTH, County Longford (IE); David SMYTH, County Longford (IE); Gerard SMYTH, County Longford (IE); Andrew SMYTH, Northern Ireland (IE)

(21) Appl. No.: 15/736,912

(22) PCT Filed: Jun. 20, 2016
(86) PCT No.: PCT/EP2016/064189

§ 371 Date: Dec. 15, 2017

(30) Foreign Application Priority Data
Jun. 18, 2015 (GB) 1510749.3
Oct. 21, 2015 (GB) 1518659.6

(51) Int. Cl. F03D 1/02; F03D 1/04; F03D 1/06

(52) U.S. Cl. CPC F03D 1/025; F03D 1/04; F05B 2240/33; F05B 2240/122; F05B 2240/221; F03D 1/0675

(57) ABSTRACT

The present invention is concerned with a wind turbine which is designed to start rotating in lower wind speeds than is conventionally possible, the wind turbine comprising a power take off shaft on which a first rotor is mounted, the first rotor having a first diameter, and on which shaft a rotatable augmentor in the form of a second rotor is mounted coaxially of the first rotor, the second rotor having a second diameter smaller than the first diameter.

### FIELD OF THE INVENTION

The present invention relates to wind turbine, and in particular a wind turbine having a first rotor and a rotating augmentor in the form of a second rotor mounted concentrically on a common power take off shaft, the second rotor being located upstream of the first rotor and adapted to assist and augment the performance of the first rotor.

### BACKGROUND OF THE INVENTION

Most modern wind turbines are horizontal axis machines comprising two or more blades having an aerofoil cross-section which utilise aerodynamic forces in order to generate lift along the length of each blade as the wind flows past the blade, such as to generate power which is then extracted by a local generator forming part of the wind turbine.

In order to ensure efficient and effective operation of a wind turbine the dynamics of the blades and their interaction with the passing wind must be taken into consideration. In particular it is important to understand that the further a point is from the root of the blade the faster that portion of the blade is moving through the air, and as a result the greater the effective wind angle at that particular point on the blade. The lift generated by the wind turbine blade is dependent on the angle of the blade relative to the oncoming wind. The effect of wind angle of the incoming wind is dependent on the rotational speed of the blade, which as mentioned above varies along the length of the blade, increasing from root to tip.

As a result it is preferable to incorporate a twist along the length of a wind turbine blade, such that at the root of the blade the cord line is substantially parallel to the direction of the oncoming wind, the blade twisting as it progresses towards the tip to a typical angle of approximately 20°. In this way the wind turbine blades can produce an even amount of power across the full diameter of the disc when operating in optimum wind speeds.

This wind turbine blade design does however give rise to a number of issues, in particular having the effect of raising the minimum wind speed at which the rotor will begin to rotate, due to the twist along the blade which means that, when stationary, a large proportion of the length of the blade is not at the optimum chord angle relative to the oncoming wind in order to generate lift and thus to begin rotation of the rotor.

It is therefore an object of the present invention to overcome the above-mentioned shortcomings of conventional wind turbine blade design.

### SUMMARY OF THE INVENTION

According to the present invention there is provided a wind turbine comprising a first rotor having a first diameter; and a rotatable augmentor in the form of a second rotor mounted coaxially of the first rotor and having a second diameter smaller than the first diameter, the second rotor being arranged to effect rotation of the first rotor.

Preferably, the first rotor can not effect rotation of the second rotor.

Preferably, the wind turbine comprises a clutch by which the second rotor is coupled to and can effect rotation of the first rotor.

Preferably, the second rotor is configured to generate, when rotating, an upstream pressure increase sufficient to deflect oncoming wind radially outward of the path of the second rotor to flow past an outer annulus of first rotor.

Preferably, the second rotor defines, when stationary, a rotor disk having a solidity of between 5% and 70%, more preferably between 30% and 40%.

Preferably, the second rotor comprises an array of primary blades configured to give the second rotor a lower start up torque than the first rotor.

Preferably, the pitch of the primary blades establishes the lower start up torque of the second rotor.

Preferably, the wind turbine comprises a shaft to which a root of each of the primary blades is secured.

Preferably, the second rotor comprises an array of secondary blades each defining a root secured radially outwardly of the shaft.

Preferably, the augmentor comprises more secondary blades than primary blades.

Preferably, the augmentor comprises one or more vortex generators.

Preferably, the one or more vortex generators are provided on one or more of the primary and/or secondary blades.

Preferably, the augmentor comprises one or more winglets provided about an outer end of one or more of the primary and/or secondary blades.

Preferably, the primary and/or secondary blades are oriented to extend in a downstream direction from root to tip.

Preferably, the augmentor comprises at least one annular shroud positioned to augment airflow across at least a portion of the primary blades and/or secondary blades.

Preferably, the augmentor comprises a pair of annular shrouds radially spaced from one another such that at least a portion of the length of the primary blades and/or secondary blades are captured between the first and second shrouds.

Preferably, the full length of each of the secondary blades is captured between the pair of annular shrouds.

Preferably, the one or more shrouds are coplanar with the primary blades and/or secondary blades.

Preferably, the one or more shrouds are formed integrally with the primary blades and/or secondary blades.

Preferably, at least one of the shrouds defines an outer rim of the second rotor.

Preferably, the outer rim comprises one or more openings to permit pressure augmentation between an interior and an exterior space defined by the outer rim.

Preferably, the outer rim circumscribes tips of at least the primary blades.

Preferably, the outer rim has a toothed or crenellated outer circumferential surface.

Preferably, the second rotor comprises a greater number of blades than the first rotor.

Preferably, the first rotor comprises at least a pair of main blades.

Preferably, each of the main blades are twisted along the length of the blade.

Preferably, each of the main blades have a reduced twist on the portion of the blade defining a swept area of diameter substantially equal to the diameter of the second rotor.

Preferably, the second rotor has a disk area of between 5% and 30% of the first rotor.

Preferably, the wind turbine comprises a housing for control systems, the housing being adapted to direct airflow towards the first and second rotors.

As used herein, the terms “upstream” and “downstream” are intended to refer to a position of an object relative to another object with respect to the direction of flow of the oncoming wind.

### BRIEF DESCRIPTION OF THE DRAWINGS

The present invention will now be described with reference to the accompanying drawings, in which:

FIG. 1 illustrates a perspective view of a wind turbine with rotating augmentor according to a first embodiment of the present invention;

FIG. 2 illustrates an enlarged perspective of the wind turbine illustrated in FIG. 1;

FIG. 3 illustrates a rear or downstream perspective view of the wind turbine of FIGS. 1 and 2;

FIG. 4 illustrates a side elevation of the wind turbine illustrated in FIGS. 1 to 3;

FIG. 5 illustrates a perspective view of a portion of the wind turbine illustrated in FIGS. 1 to 4;

FIG. 6 illustrates a perspective view of a wind turbine with rotating augmentor according to a second embodiment of the present invention, from an upstream perspective;

FIG. 7 illustrates a rear or downstream perspective view of the wind turbine of FIG. 6;

FIG. 8 illustrates a side elevation of the wind turbine illustrated in FIGS. 6 and 7; and

FIG. 9 illustrates a perspective view of a portion of the wind turbine illustrated in FIGS. 6 to 8.

### DETAILED DESCRIPTION OF THE DRAWINGS

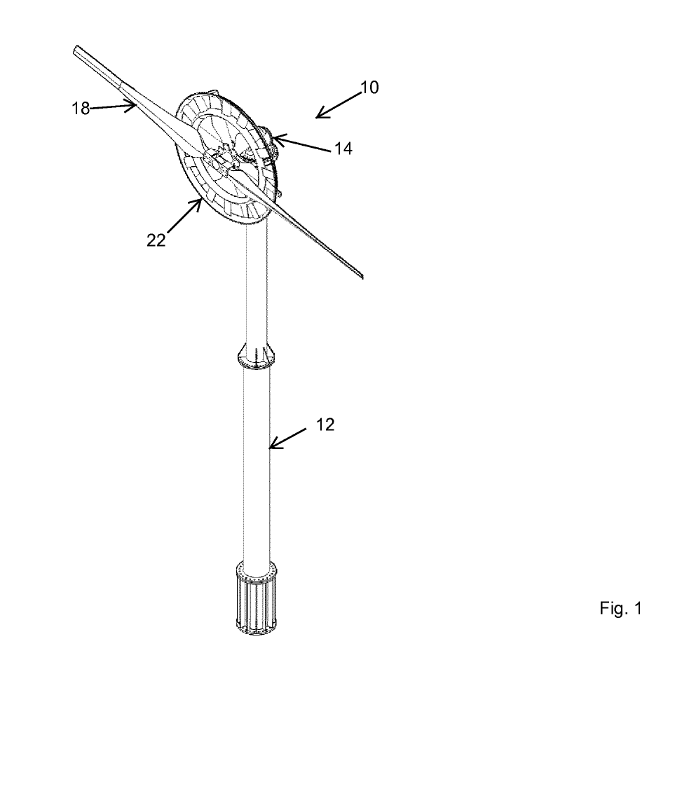

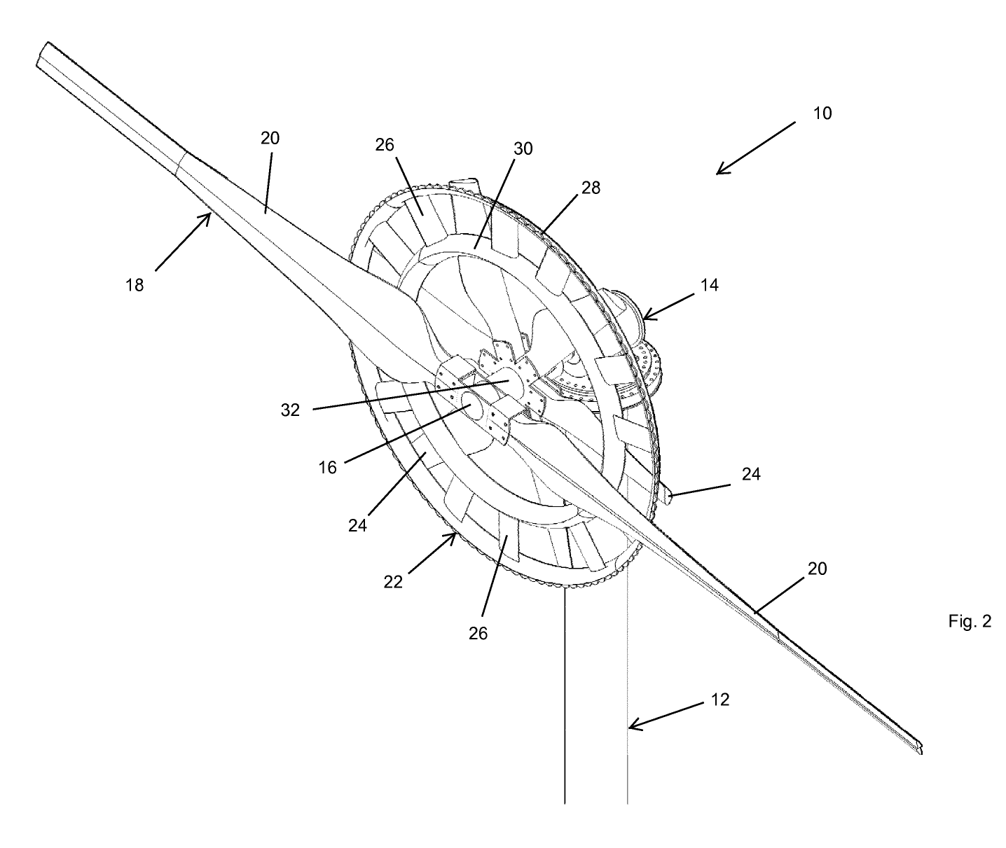

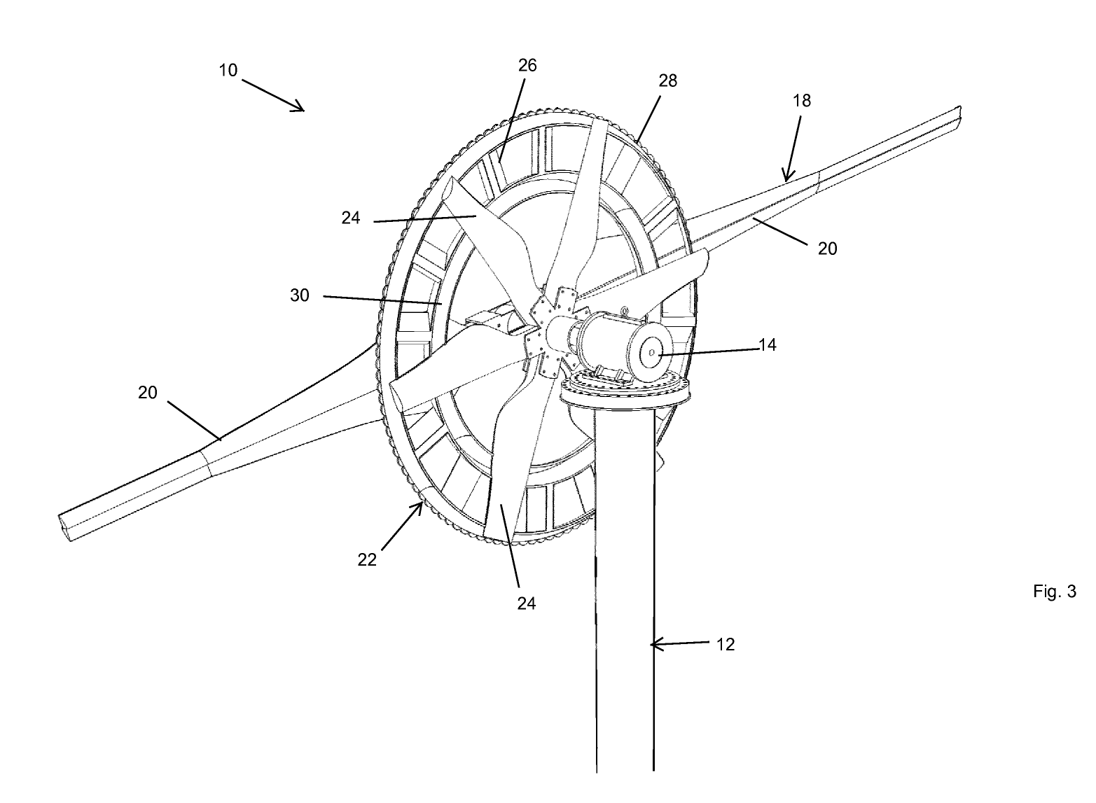

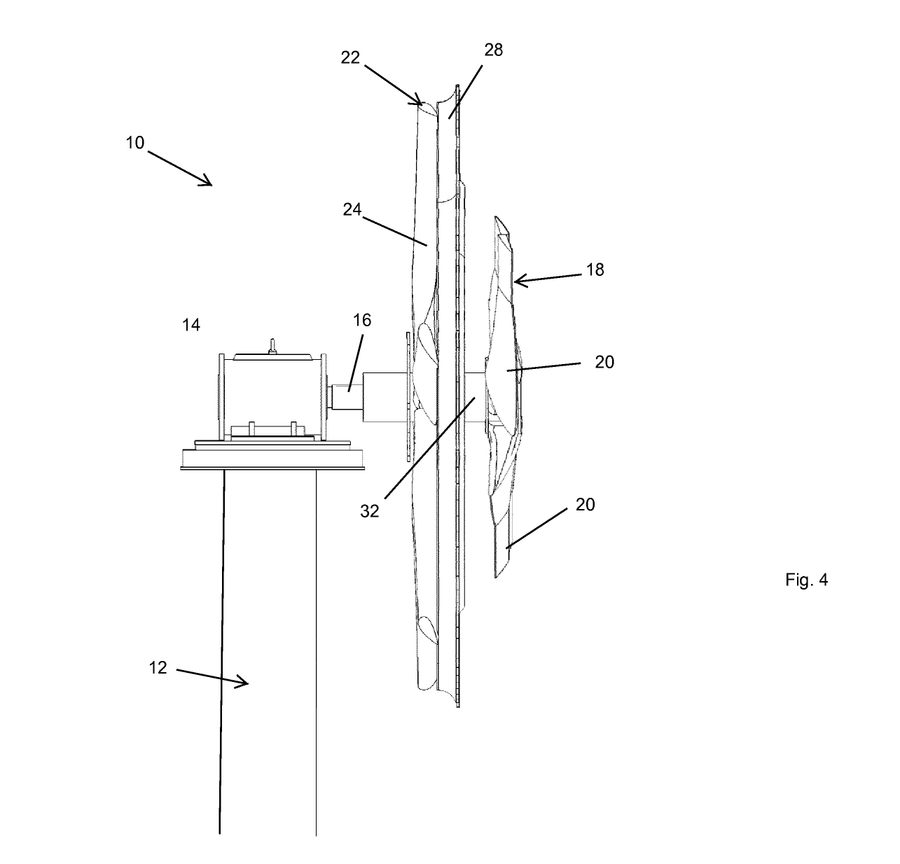

Referring now to FIGS. 1 to 5 of the accompanying drawings there is illustrates a first embodiment of a wind turbine, generally indicated as 10, for use in more efficiently and effectively extracting power from a flow of wind or other working fluid, which can then be converted to another desired form of energy, most conventionally into electrical energy. However the wind turbine 10 could for example be connected to a mechanical output such as a water pump or water treatment system (not shown) or the like. Similarly the turbine 10 may be connected to a battery (not shown) or equivalent electrical storage device, in order to provide a total energy solution.

The wind turbine 10 comprises a substantially conventional construction, having a vertical mast 12 which is topped with a nacelle 14 within which the conventional working components of the wind turbine 10, in particular the electrical generator, gear assembly and any other related components (not shown), are housed. No further explanation of these conventional components is therefore deemed necessary.

Extending from the nacelle 14 is a substantially horizontal power takeoff shaft 16. Mounted to the shaft 16 is a first rotor 18 which, in the embodiment illustrated, is a twin bladed rotor 18 utilising a pair of substantially conventional twisted main blades 20, the details of which will be explained in greater detail hereinafter. Mounted to the power takeoff shaft 16 in a position downstream of the first rotor 18 with respect to the direction of the oncoming wind is a rotatable augmentor in the form of a second rotor 22 which, in the embodiment illustrated, is smaller in diameter than the first rotor 18 and is of multi-blade design, again as will be described in greater detail. This second rotor 22 provides dual functionality to the turbine 10 to improve the operation and efficiency thereof. In particular the second rotor 22 is designed, as will be described hereinafter, to have a lower start-up torque than the first rotor 18, allowing the second rotor 22 to be driven by lower wind speeds than those conventionally required to start a wind turbine, and that are necessary to start the first rotor 18.

In addition, once rotating at normal operating speeds, the second rotor 22 is designed to augment or deflect the oncoming wind radially outwardly towards the outer region of the main blades 20, in which region greater power/torque may be generated by the main blades 20. These combined functions of the second rotor 22 ensure that the turbine 10 can start in lower wind speeds than conventionally necessary, and that more power can then be generated from the wind flowing past the turbine 10. This functionality is achieved through a combination of features forming the second rotor 22, including a set of primary blades 24 which extend from the shaft 16, and an array of secondary blades 26 which are captured between a wind augmenting outer shroud 28 and radially spaced inner shroud 30.

The first rotor 18 and second rotor 20 are separated from one another on the shaft 16 by means of a clutch 32, and the configuration and operation of the clutch 32 will be described in detail hereinafter, but essentially permits the power takeoff shaft 16 to rotate and achieve higher revolutions per minute (RPM) at low wind speeds than would otherwise be achieved with the second rotor 22 attached to the power takeoff shaft without the clutch 32. The clutch 32 permits torque to be transmitted in one direction only, namely from the second rotor 22 back along power take off shaft 16 to the first rotor 18, but not from the first rotor 18 to the second rotor 22.

The purpose of the second rotor 22 is to maximise torque generation of the overall wind turbine 10 at lower wind speeds, resulting in the larger first rotor 18 beginning to rotate at lower wind speeds than would be the case without the second rotor 22, while also reducing drag generated on the larger first rotor 18, in particular at the root of the individual blades 24, thereby overcoming some of the limitations of conventional twist blade design. The smaller second rotor 22 is also preferably provided with a toothed or crenelated rim on the outer shroud 28 which is designed to minimise drag, during use, on the second rotor 22.

The individual primary blades 24 of the second rotor 22 may be pitched in such a manner, or otherwise configured or designed, such as to maximise the lift and therefore torque generated by the second rotor 22 at lower wind speeds, therefore resulting in an earlier overcoming or starting moment of inertia. Thus the second rotor 22 will begin to rotate at a wind speed lower than would be required to start the larger first rotor 18. However as the first rotor 18 and second rotor 22 are connected by means of the power take off shaft 16, with the clutch 32 therebetween, rotation of the second rotor 22 will result in the instantaneous rotation of the first rotor 18. Thus the second rotor 22 can be designed to start at lower wind speeds, and via the shaft 16, to also force the first rotor 18 to begin rotating at a lower wind speed than would otherwise be achievable.

Once the second rotor 22 has reached normal rotational speeds, the large number of primary blades 24, in combination with the supplementary secondary blades 26, will result in the second rotor 22 having an effective solidity which will act to deflect the oncoming wind radially outwardly around this perceived solid disk. This will result in a larger volume of the oncoming airflow being pushed outwardly to flow past the radially outer portion or region of the main blades 20, which through aerodynamic design, are adapted to extract power from higher wind speeds, and will thus generate larger amounts of torque relative to the inner portions of the blades 20. In the preferred embodiment the second rotor 22 will have a solidity, when stationary, of between 5% and 70%, more preferably between 30% and 40%. It will also be understood that the second rotor 22 has a smaller diameter than the first rotor 18, and preferably a diameter of between 20-80% of the first rotor 18. The second rotor 22 preferably has a disk area of between 5% and 30% of the first rotor 18

The number of both primary blades 24 and secondary blades 26 may be varied as necessary, although it has been found that between six and eight primary blades 24 is optimum, most preferably six primary blades 24. The primary blades 24 are preferably mounted or otherwise connected directly to the shaft 16, in the present embodiment by means of a hub 34, and preferably extend radially outwardly to the outer circumference of the second rotor 22. In the region just radially outwardly of the hub 34 the relatively large chord thickness of the primary blades 24 will ensure that the desired disk solidity is achieved when the second rotor 22 is at operational speeds. However, towards the tips of the primary blades 24 there is more “empty” space between the blades 24, and so the secondary blades 26 populate this otherwise empty space, again to ensure that the desired disk solidity is achieve across the entire face of the rotor disk.

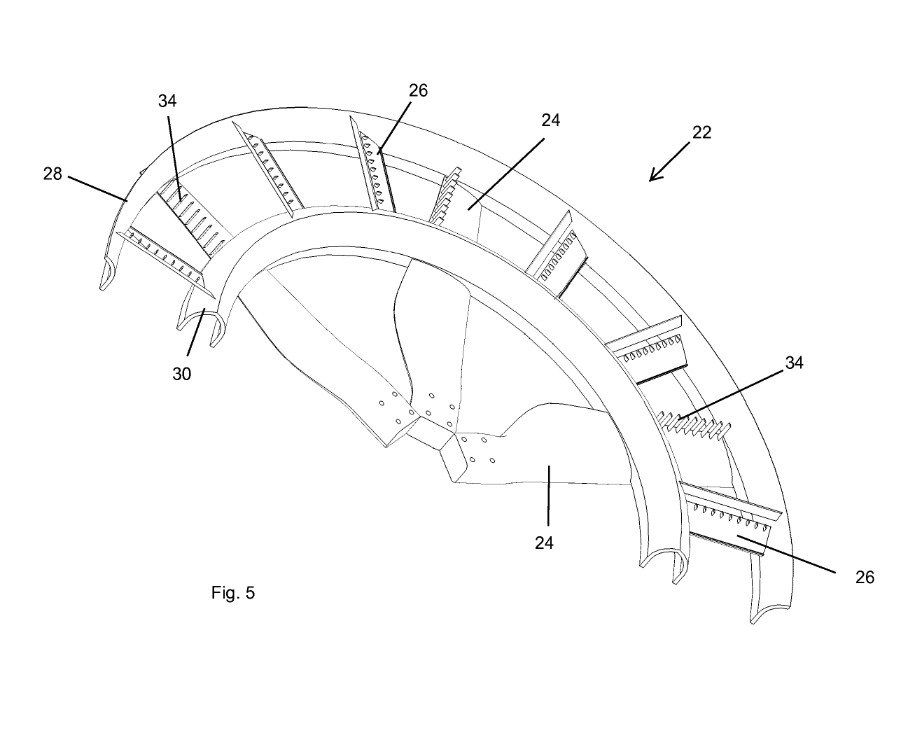

Due to the relatively short length of the secondary blades 26 between root and tip, the second rotor 22 incorporates the outer and inner shrouds 28, 30, which together serve to channel and thus accelerate the oncoming wind across the full length of each secondary blade 26, in order fully utilise the lift generating capacity of each of the blades 26. In addition the shrouds 28, 30 channel and acerbate the airflow over the corresponding portion of each of the primary blades 24, further increasing the efficiency of the second rotor 22, additionally reducing the start up torque. The shrouds 28, 30 are thus preferably shaped and/or arranged to define at least a convergent flow path, and optionally a convergent to divergent flow path, from the perspective on the oncoming wind as it flows through the channel defined between the shrouds 28, 30 and across the secondary blades 26 and the captured portion of the primary blades 24. This profiled flow path can be seen in FIG. 5.

In addition it is preferable but not essential that the individual primary and secondary blades 24, 26 of the second rotor 22 extend in a slight rearward direction with respect to the direction of the oncoming wind, from root to tip. This rearward extension of the blades results in the second rotor 22, when rotating, being perceived by the oncoming wind as a conical surface having an effective apex at the shaft 16 and a base defined by the outer shroud 28. By providing the second rotor 22 with a higher number of primary blades 24, for example six to eight blades 24, the second rotor 22 will effectively be perceived by the oncoming wind as a solid conical surface once the second rotor 22 is rotating at operational speeds and will therefore deflect the oncoming wind. This deflected wind will follow a natural path around this perceived cone, mixing with the oncoming wind radially outboard of the second rotor 22 which is directly proceeding towards the larger main blades 20 of the first rotor 18. This deflected or redirected airflow will result in a higher overall velocity and volume of the airflow incident on the larger main blades 20 of the first rotor 18, in particular the outer region of the main blades 20, which are capable of generating greater amounts of torque than the inner portion of the blades. The primary and/or secondary blades 24, 26 may also be provided with vortex generators 34 (seen in FIG. 5) in order to improve the aerodynamics of the flow around the blades 24, 26 and to reduce flow separation.

As the second rotor 22, and in particular the primary blades 24, are pitched or otherwise adapted to generate lift and therefore torque at low wind speeds, the second rotor 22 will reach its optimum speed of rotation at a lower wind speed than is optimum for the first rotor 18. Beyond this optimum speed the second rotor 22 will begin to generate greater amounts of drag and will thus suffer from reduced efficiency at higher wind speeds. As the first rotor 18 is connected to the second rotor 22 via the power takeoff shaft 16, the first rotor 18 could continue to drive the second rotor 22 past its optimum speed, as the first rotor 18 is designed to operate optimally at wind speeds higher than the optimal wind speed of the second rotor 22. However the provision of the clutch 32 allows the first rotor 18 to accelerate beyond the optimal speed of rotation of the second rotor 22, while permitting the second rotor 22 to continue rotating at this speed, thereby avoiding the above-mentioned increase in drag at the second rotor 22.

The larger first rotor 18 preferably comprises a pair of the main blades 20, although it will of course be appreciated that three or more of the blades 20 may be provided. However the higher the number of main blades 20, the greater the drag generated by the first rotor 18, and thus the larger the mast 12 must be in order to resist the bending forces generated by drag on the first rotor 18. The design or profile of the blades 20 preferably differs from a conventional turbine blade which normally has a chord line, at the root of the blade, substantially parallel to the oncoming wind. The modified design of the blades 20 provides a lesser twist angle in the region of the root of the blades 20 than will be apparent on the outer portion of the blades 20 beyond the outer circumference of the second rotor 22. This is possible because the portion of the blades 20 which, due to the upstream pressure increase established by the second rotor 22, are in the “shadow” of the second rotor 22 and so will be subjected to little if any exposure to the wind during operation, which will be deflected outwardly by the operation of the second rotor 22 to flow past the outer portion of the blades 20 beyond the second rotor 22. There is thus no requirement to incorporate the normal twist along the inner shadowed portion of the blades 20. The main blades 20 preferably incorporate the greatest twist in the middle third of the length of each blade 20.

The purpose of the larger twin bladed first rotor 18 is to reduce drag and maximise the lift generated at lower wind speeds due to the much higher RPM of the turbine 10 at lower wind speeds and additional augmented flow due to the smaller second rotor 22 deflecting the oncoming wind onto the blades 20 of the first rotor 18. However it will be appreciated that a set of conventional twist blades (not shown) could be employed in the first rotor 18, but would result in reduced efficiency due to the extra drag generated at the root of said conventional blades.

Thus in use, from a stationary state the oncoming wind will flow past the two main blades 20 and across the downstream second rotor 22, which due to the large number and selective pitch of the blades 24, 26, will begin to rotate at a lower wind speed then would be capable of starting the first rotor 18. Rotation of the second rotor 22 is transmitted, via the clutch 32, through the power takeoff shaft 16 to the first rotor 18, which will therefore undergo rotation at wind speeds lower than those conventionally necessary to initialise rotation of such a rotor. Thus the blades 20 of the first rotor 18 can begin to extract power at lower wind speeds. In addition once the smaller second rotor 22 is up to speed it will present a solid disk or cone to the oncoming wind. This effectively solid disk defined by the second rotor 22 with create a region of increased pressure directly upstream of the second rotor 22, including the corresponding disk area of the main blades 20, which will act to deflect the oncoming airflow around the effectively solid second rotor 22, increasing the volume and velocity of airflow past the outer region of the main blades 20 of the first rotor 18.

This increased airflow will drive the first rotor 18 beyond the above-mentioned optimal speed of rotation of the second rotor 22, which by virtue of the clutch 32, will not be forced to rotate at the same speed as the first rotor 18, which would otherwise result in the generation of unnecessary levels of drag at the first rotor 18. It will therefore be appreciated that the second rotor 22 acts to start the first rotor 18 rotating at lower than conventional wind speeds, and the clutch 32 then allows the first rotor 18 to continue to increase in speed in order to continue to extract greater levels of power from the oncoming wind. While in the preferred embodiment illustrated the second rotor 22 is positioned downstream of the first rotor 18 with respect to the direction the wind is blowing, it is also feasible to place the second rotor 22 upstream of the first rotor 18. Similarly it should be understood that the number and design of the primary blades 24, the secondary blades 26, and the shrouds 28, 30 may be varied to give desired performance characteristics, while maintained the above described functionality.

As noted above, the wind turbine 10 may be connected to a battery (not shown) or equivalent electrical storage device, in order to provide a total energy solution. It is envisaged that in such a configuration the wind turbine 10 may also comprise a housing (not shown) to accommodate all related componentry such as control equipment or systems, transformers or other voltage and/or current conditioning hardware or the like. The housing is preferably located at a foot of the mast 12, but may be located at any other suitable location. The housing is also preferably positioned and shaped to function as a further augmentor of air flow, preferably having at least an upper surface or roof (not shown) which deflects airflow towards the rotors 18, 22 in order to further increase power generation. The housing may also function as a support on which one or more solar panels may be provided, in order to supplement power generated from the wind. Such an arrangement may also be utilised as a power take off point, for example for charging electric vehicles or the like.

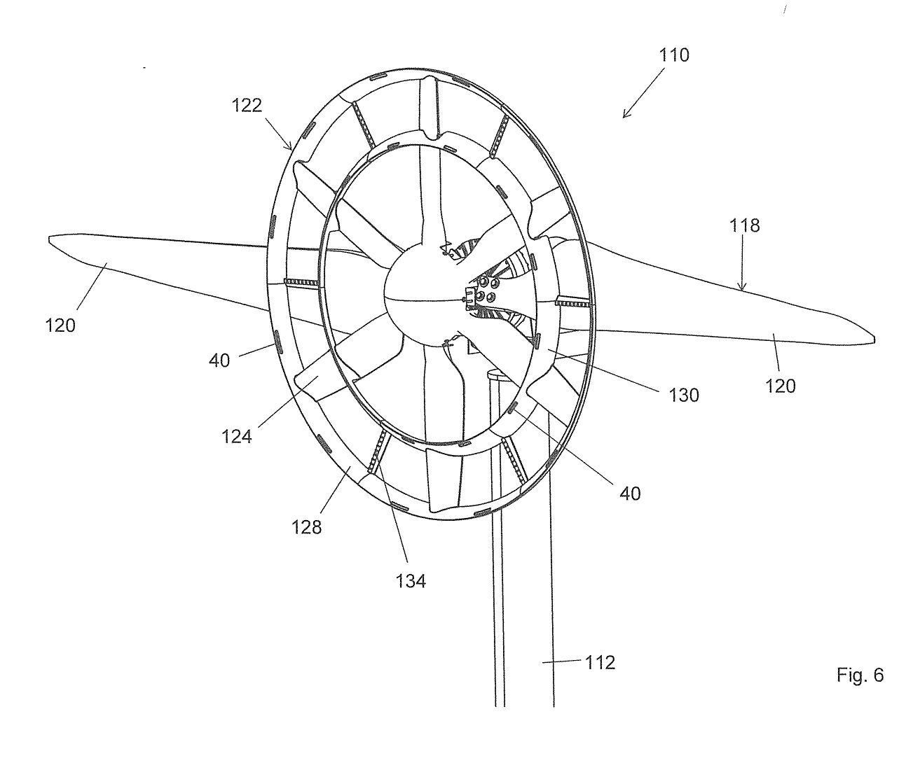

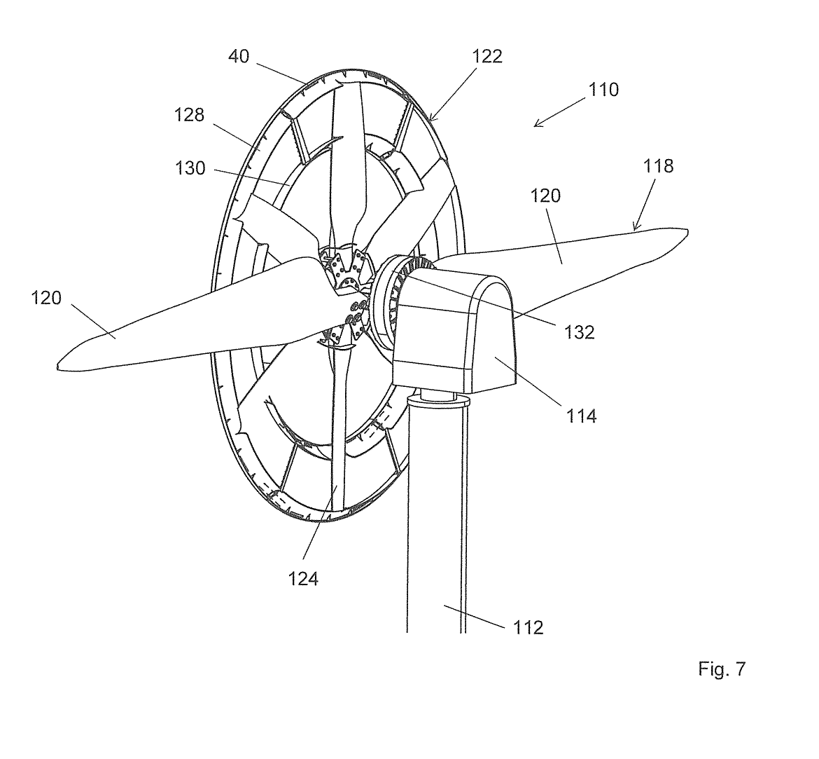

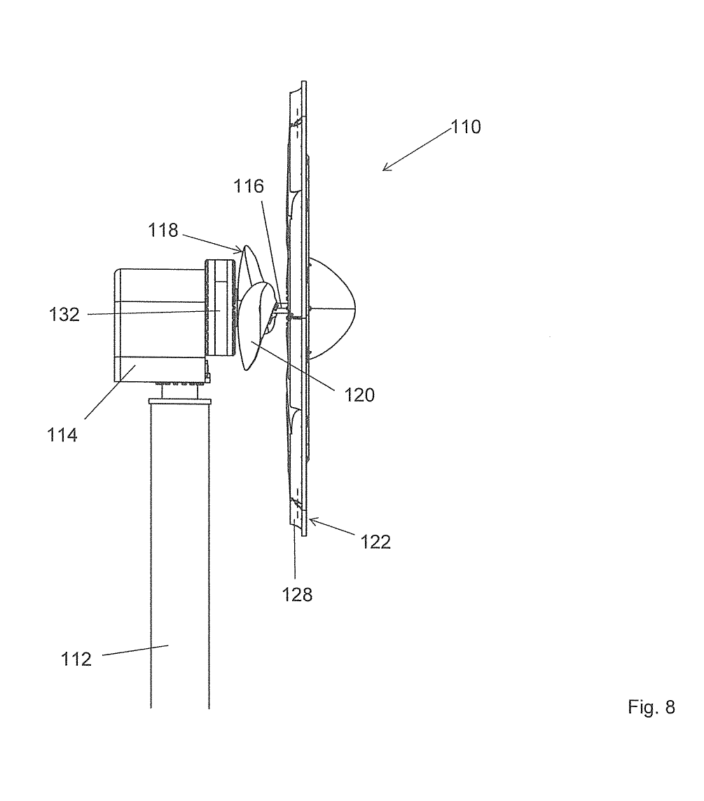

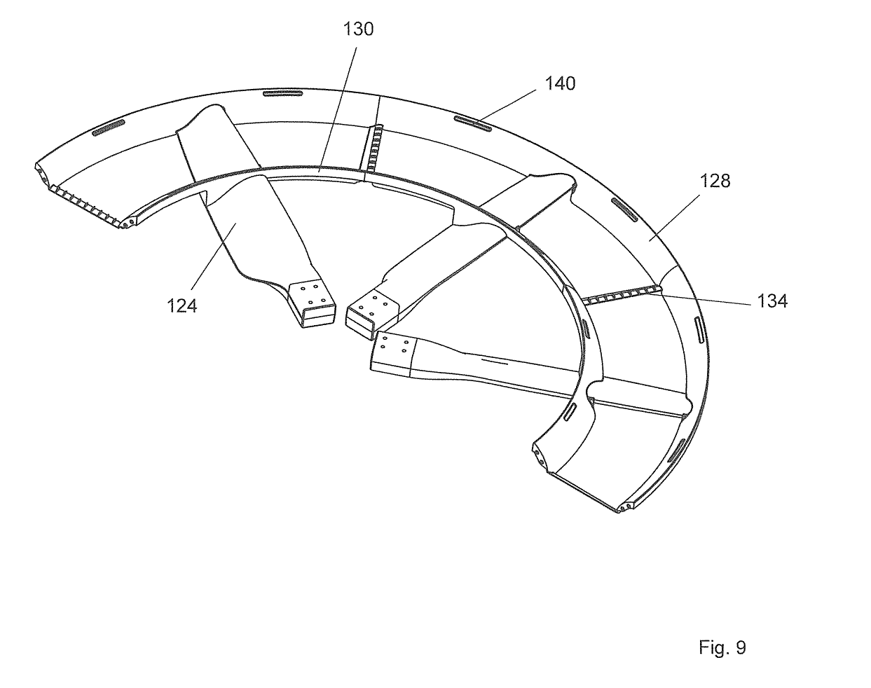

Referring now to FIGS. 6 to 9 there is illustrated a second embodiment of a wind turbine according to the present invention, generally indicated as 110. In this second embodiment like components have been accorded like reference numerals, and unless otherwise stated perform a like function.

The wind turbine 110 comprises a substantially conventional construction, having a vertical mast 112 which is topped with a nacelle 114 within which the conventional working components of the wind turbine 110, in particular the electrical generator, gear assembly and any other related components (not shown), are housed. Extending from the nacelle 114 is a substantially horizontal power takeoff shaft 116. Mounted to the shaft 116 is a first rotor 118 which, in the embodiment illustrated, is a twin bladed rotor 118 utilising a pair of substantially conventional twisted main blades 120, essentially identical in configuration and operation to the blades 20 of the first embodiment. Mounted to the power takeoff shaft 116 in a position upstream of the first rotor 118 with respect to the direction of the oncoming wind is a rotatable augmentor in the form of a second rotor 122 which is again smaller in diameter than the first rotor 118 and provides the same dual functionality as the rotor 22 of the first embodiment, having a lower start-up torque than the first rotor 118 and augmenting the oncoming wind radially outwardly towards the outer region of the main blades 120. As with the rotor 22 of the first embodiment, the second rotor 122 comprises a set of primary blades 124 which extend from the shaft 116, in addition to an augmenting outer shroud 128 and radially spaced inner shroud 130. The second rotor 122 does not however incorporate secondary blades as with the first embodiment. The outer shroud 128 and the inner shroud 130 each incorporate one or more openings 140 to permit pressure augmentation between an interior and an exterior space defined by the respective rim 128, 130. The shrouds 128, 130 are shaped and/or arranged to define at least a convergent flow path, and optionally a convergent to divergent flow path, from the perspective on the oncoming wind as it flows through the channel defined between the shrouds 128, 130 and across the the captured portion of the primary blades 124.

The first rotor 118 and second rotor 120 are connected to one another on the shaft 116 by means of a clutch 132 having the same function as the clutch 32 of the first embodiment, permitting rotation of the second rotor 120 to be transmitted from the power takeoff shaft 116 to the first rotor 118 in order to effect the simultaneous rotation thereof. Thus the first rotor 118 will begin to rotate at lower wind speeds than would otherwise be achieved without the second rotor 122. The clutch 132 permits torque to be transmitted in one direction only, namely from the second rotor 122 back along power take off shaft 116 to the first rotor 118, but not from the first rotor 118 to the second rotor 122. Thus the first rotor 118 can rotate faster than the second rotor 120 in suitable wind speeds as hereinbefore described with reference to the first embodiment of the invention.

The purpose of the second rotor 122 is to maximise torque generation of the overall wind turbine 110 at lower wind speeds, resulting in the larger first rotor 118 beginning to rotate at lower wind speeds than would be the case without the second rotor 122, while also reducing drag generated on the larger first rotor 118, in particular at the root of the individual blades 124. The smaller second rotor 122 is also preferably provided with a toothed or crenelated rim on the outer shroud 128 which is designed to minimise drag, during use, on the second rotor 122.

The individual primary blades 124 of the second rotor 122 may be pitched in such a manner, or otherwise configured or designed, such as to maximise the lift and therefore torque generated by the second rotor 122 at lower wind speeds, therefore resulting in an earlier overcoming or starting moment of inertia. Thus the second rotor 122 can be designed to start at lower wind speeds, and via the shaft 116, to also force the first rotor 118 to begin rotating at a lower wind speed than would otherwise be achievable. Once the second rotor 122 has reached normal rotational speeds, the primary blades 124 will result in the second rotor 122 having a solidity which will act to deflect the oncoming wind radially outwardly around this perceived solid disk. This will result in a larger volume of the oncoming airflow being pushed outwardly to flow past the outer portion or region of the main blades 120, which through design, are adapted to extract power from higher wind speeds, and will thus generate larger amounts of torque relative to the inner portions of the blades 120. In this second embodiment the second rotor 122 will have a solidity, when stationary, of between 5% and 70%, more preferably between 30% and 40%. It will also be understood that the second rotor 122 has a smaller diameter than the first rotor 118, and preferably a diameter of between 20-80% of the first rotor 118. The second rotor 122 preferably has a disk area of between 5% and 30% of the first rotor 118

The number of primary blades 124 may again be varied as necessary, although it has been found that between six and eight primary blades 124 is optimum, most preferably six primary blades 124. The primary blades 124 are mounted directly to the shaft 116 by means of a hub 134, and preferably extend radially outwardly to the outer circumference of the second rotor 122. In the region just radially outwardly of the hub 134 the relatively large chord thickness of the primary blades 124 will ensure that the desired disk solidity is achieved when the second rotor 122 is at operational speeds.

The second rotor 122 incorporates the outer and inner shrouds 128, 130, which together serve to channel and thus accelerate the oncoming wind across the captured portion of each primary blade 124 which, in the embodiment illustrated, is that portion of the blades 124 which are capable of extracting most power from the wind at normal operating speeds. The primary blades 124 may also be provided with vortex generators 134 (seen in FIG. 6) in order to improve the aerodynamics of the flow around the blades 124 and to reduce flow separation.

As the second rotor 122, and in particular the primary blades 124, are pitched or otherwise adapted to generate lift and therefore torque at low wind speeds, the second rotor 122 will reach its optimum speed of rotation at a lower wind speed than is optimum for the first rotor 118. Beyond this optimum speed the second rotor 122 will begin to generate greater amounts of drag and will thus suffer from reduced efficiency at higher wind speeds. As the first rotor 118 is connected to the second rotor 122 via the power takeoff shaft 116, the first rotor 118 could continue to drive the second rotor 122 past its optimum speed, as the first rotor 118 is designed to operate optimally at wind speeds higher than the optimal wind speed of the second rotor 122. The provision of the clutch 132 allows the first rotor 118 to accelerate beyond the optimal speed of rotation of the second rotor 122, while permitting the second rotor 122 to continue rotating at this speed, thereby avoiding the above-mentioned increase in drag at the second rotor 122.

As with the first embodiment the larger first rotor 118 preferably comprises a pair of the main blades 120, although it will of course be appreciated that three or more of the blades 120 may be provided. However the higher the number of main blades 120, the greater the drag generated by the first rotor 118, and thus the larger the mast 112 must be in order to resist the bending forces generated by drag on the first rotor 18. The design or profile of the blades 120 preferably differs from a conventional turbine blade which normally has a chord line, at the root of the blade, substantially parallel to the oncoming wind. The modified design of the blades 120 provides a lesser twist angle in the region of the root of the blades 120 than will be apparent on the outer portion of the blades 120 beyond the outer circumference of the second rotor 122. This is possible because the portion of the blades 120 which are in the “shadow” of the second rotor 122 will be subjected to little if any exposure to the wind during operation, which will be deflected outwardly by the second rotor 122 to flow past the outer portion of the blades 120 beyond the second rotor 122. There is thus no requirement to incorporate the normal twist along the inner shadowed portion of the blades 120. The main blades 120 preferably incorporate the greatest twist in the middle third of the length of each blade 120.

As with the first embodiment, a set of conventional twist blades (not shown) could be employed in the first rotor 118, but would result in reduced efficiency due to the extra drag generated at the root of said conventional blades.

1. A wind turbine comprising:
a first rotor having a first diameter; and
a rotatable augmentor in the form of a second rotor mounted coaxially of the first rotor and having a second diameter smaller than the first diameter, the second rotor being arranged to effect rotation of the first rotor.

2. The wind turbine of claim 1, wherein the first rotor can not effect rotation of the second rotor.

3. The wind turbine of claim 1, further comprising a clutch by which the second rotor is coupled to and can effect rotation of the first rotor.

4. The wind turbine of claim 1, wherein the second rotor is configured to generate, when rotating, an upstream pressure increase sufficient to deflect oncoming wind radially outward of the path of the second rotor to flow past an outer annulus of the first rotor.

5. The wind turbine of claim 1, wherein the second rotor defines, when stationary, a rotor disk having a solidity of between 5% and 70%, more preferably between 30% and 40%.

6. The wind turbine of claim 1, wherein the second rotor comprises an array of primary blades configured to give the second rotor a lower start up torque than the first rotor.

7. The wind turbine of claim 6, wherein the pitch of the primary blades establishes the lower start up torque of the second rotor.

8. The wind turbine of claim 6, further comprising a shaft to which a root of each of the primary blades is secured.

9. The wind turbine of claim 8, wherein the second rotor comprises an array of secondary blades each defining a root secured radially outwardly of the shaft.

10. The wind turbine of claim 9, wherein the augmentor comprises more secondary blades than primary blades.

11. The wind turbine of claim 6, wherein the augmentor comprises one or more vortex generators.

12. The wind turbine of claim 11, wherein the one or more vortex generators are provided on at least one of the group consisting of the primary blades and the secondary blades.

13. The wind turbine of claim 6, wherein the augmentor comprises one or more winglets provided about an outer end of at least one of the group consisting of the primary blades and the secondary blades.

14. The wind turbine of claim 6, wherein at least one of the group consisting of the primary blades and the secondary blades are oriented to extend in a downstream direction from root to tip.

15. The wind turbine of claim 6, wherein the augmentor comprises at least one annular shroud positioned to augment airflow across at least a portion of at least one of the group consisting of the primary blades and the secondary blades.

16. The wind turbine of claim 15, wherein the augmentor comprises a pair of annular shrouds radially spaced from one another such that at least a portion of the length of at least one of the group consisting of the primary blades and the secondary blades are captured between the first and second shrouds.

17. The wind turbine of claim 16, wherein the full length of each of the secondary blades is captured between the pair of annular shrouds.

18. The wind turbine of claim 15, wherein the one or more shrouds are coplanar with at least one of the group consisting of the primary blades and the secondary blades.

19. The wind turbine of claim 15, wherein the one or more shrouds are formed integrally with at least one of the group consisting of the primary blades and the secondary blades.

20. The wind turbine of claim 15, wherein at least one of the shrouds defines an outer rim of the second rotor.

21. The wind turbine of claim 20, wherein the outer rim comprises one or more openings to permit pressure augmentation between an interior and an exterior space defined by the outer rim.

22. The wind turbine of claim 20, wherein the outer rim circumscribes tips of at least the primary blades.

23. The wind turbine of claim 20, wherein the outer rim has a toothed or crenellated outer circumferential surface.

24. The wind turbine of claim 1, wherein the second rotor comprises a greater number of blades than the first rotor.

25. The wind turbine of claim 1, wherein the first rotor comprises at least a pair of main blades.

26. A wind turbine according to claim 25 in which The wind turbine of claim 25, wherein each of the main blades are twisted along the length of the blade.

27. The wind turbine of claim 26, wherein each of the main blades have a reduced twist on the portion of the blade defining a swept area of diameter substantially equal to the diameter of the second rotor.

28. The wind turbine of claim 1, wherein the second rotor has a disk area of between 5% and 30% of the first rotor.

29. The wind turbine of claim 1, further comprising a housing for control systems, the housing being adapted to direct airflow towards the first and second rotors.
